(19) United States
(12) Patent Application Publication
(10) Pub. No.: US 2006/0126021 A1
(43) Pub. Date: Jun. 15, 2006

(54) Scrolling color system with ac-operated lamp

(76) Inventors: Gerardus Johannes Josephus Vanlier, EINDHOVEN (NL); Adrianus Johannes Stephanes Maria De Vaan, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/523,390

(22) PCT Filed: Jul. 4, 2003
(86) PCT No.: PCT/IB03/02713

§ 371 Date: Feb. 1, 2005

(30) Foreign Application Priority Data
Aug. 1, 2002 (EP) 02078159.7

(51) Int. Cl. G03B 21/00; H04N 9/12

(52) U.S. Cl. 353/31; 348/742

(57) ABSTRACT

A color projection system is disclosed, comprising a light valve device (4) for modulating light incident thereon in accordance with information of the image to be displayed, an AC-operated light source (1) for generating light of at least two different colors, and an illumination unit (3) for illuminating said light valve device with said generated light of different colors in a sequential fashion. The light valve device is controlled in synchronization with said illumination unit (3) in order to produce a colored output image. Furthermore, the sequential color cycle of the light valve device (4) and the AC cycle for the illumination unit are adapted to be out of phase with each other. A method of operating such a projection system is also disclosed.

The present invention relates to a color projection system comprising a light valve device for modulating light incident thereon in accordance with information of the image to be displayed, an AC-operated light source for generating light of at least two different colors, and an illumination unit for illuminating said light valve device with said generated light of different colors in a sequential fashion, wherein said light valve device is controlled in synchronization with said illumination unit in order to produce a colored output image. The invention also relates to a method of operating such a projection system.

Projection television (PTV) and video color display systems, especially rear projection display systems, are a popular way of producing large screen displays, as the projection method provides displays which are lighter, cheaper and, in may cases, superior in brightness and contrast as compared with non-projection based displays.

Different ways of obtaining the different colors in a sequential fashion are known in the art. For example, it is known to use a special light source which pulses primary color beams sequentially (see, for example, GB-A-2 172 733). Furthermore, EP 0 492 721 and U.S. Pat. No. 6,097,352 disclose systems in which bar-shaped beams of different colors are continuously scrolled over a light valve device, wherein the light valve is operated in order to modulate the light in accordance with information about the image to be displayed, and in synchronization with the sequentially scrolled colors. It is also known to use color wheels for providing the different colors. This is disclosed in e.g. U.S. Pat. No. 5,967,636.

A DC-operated lamp could be used as a light source. However, this type of light source is subject to several drawbacks. For example, it is very sensitive to temperature stress, and its lifetime is therefore limited. This makes this type of lamp unreliable and costly to use. For this reason, it is normally preferred to use AC-operated light sources. However, even this type of light source is associated with certain problems, such as achieving an adequate synchronization of the lamp current and a sequential color cycle.

Another problem is to stabilize the arc to prevent arc jumping effects that become visible as light flicker in the projected image. Within the field of AC-operated lamps, this is solved by introducing an extra lamp-stabilization pulse on the lamp current. Furthermore, the time period of the AC lamp and the sequential color cycle are synchronized to obtain a stable color reproduction. However, in the case of a scrolling color type of architecture, this leads to significant visible defects and artefacts, such as visible color bars, in the displayed image. Artefacts are caused by the fact that the AC-operated lamp has also an AC component in the light output which interferes with the color sequence on a light valve.

It is therefore an object of the present invention to provide a color projection system as defined in the opening paragraph having reduced visible defects and artefacts and a method of operating a color projection system as defined in the opening paragraph having reduced visible defects and artefacts.

This object is achieved with a projection system as defined in claim 1 and a method as defined in claim 7.

According to a first aspect of the invention, a color projection system is provided, comprising a light valve device for modulating light incident thereon in accordance with information of the image to be displayed, an AC-operated light source for generating light of at least two different colors, and an illumination unit for illuminating said light valve device with said generated light of different colors in a sequential fashion, wherein said light valve device is controlled in synchronization with said illumination unit in order to produce a colored output image, and wherein the sequential color cycle of the light valve device and the AC cycle for the illumination unit are adapted to be out of phase with each other.

Thus, the invention relates to a drive scheme for the lamp current in relation to the light valve drive scheme of scrolling color type of projection systems in order to minimize interference between the scrolling colors and the lamp drive pulses. With the inventive system, the interference between the scrolling colors and the lamp drive pulses could be significantly reduced.

In this application, the sequential color cycle is understood to be the time period during which the colors are scrolled one rotation. This is also referred to as the display frame time.

The light valve device is preferably a transmissive or a reflective liquid crystal device.

In a preferred embodiment, the illumination unit is further adapted to generate different colors in a space-multiplexed fashion. At any certain moment of time, at least two, and preferably all colors are projected on the light valve. In this way, color reproduction also depends on the spatial addressing of the light valve, which renders the colored image production more effective. Furthermore, it is preferred that the illumination unit is operable to provide scrolling color projection, wherein the colors are arranged with a band-shaped cross-section.

A combination of time and space-sequential color illumination is preferred. A general aim is to generate a projection system using only a single light valve so as to reduce the cost of the system. Color reproduction is then obtained in a color-sequential way, wherein each individual pixel generates red, green and blue light with their proper intensities time-sequentially. Standard architectures for this type of device use a color wheel to produce these color flashes. The color wheel has filter elements that time-sequentially pass the illumination light beam, such that the entire display is illuminated with one of the primary colors, and is time-sequentially illuminated with all the primary colors. For example, when the panel is illuminated with green, the red and blue light is blocked by the color wheel. However, such a display has a limited system efficiency. Since two of the three primary colors are discarded each moment of time, the system efficiency drops by 66% only to generate colors.

A scrolling color system solves this principal light loss for color generation. In scrolling color systems, the white light of the light source is split into colored bars of different colors, generally three colored bars for red, green and blue. The system is designed in such a way that all of the three bars are incident on the same display panel, however, on a different location. The three bars are swept time-sequentially on the display. Still, each pixel time-sequentially controls the light traversing to the screen, but in this case different pixels control different colors at every moment of time.

According to another aspect of the invention, a method of controlling a projection system as defined above is provided. Similar advantages as discussed above are achieved with this method.

According to one line of embodiments, the period of time of the AC current cycle is longer than the period of time of the sequential color cycle. However, according to a more preferred line of embodiments, the period of time of the AC current cycle is shorter than the period of time of the sequential color cycle. This could be achieved by letting the period of time of the AC current cycle be shorter than the ordinary display frame time of the sequential color cycle. Alternatively, the at least one white segment could be introduced in the sequential color cycle, providing an addition to the ordinary display frame time, wherein the period of time of the AC current cycle becomes shorter than said aggregate time period of the sequential color cycle.

The invention will now be described in greater detail by way of example, with reference to embodiments illustrated in the accompanying drawings, wherein:

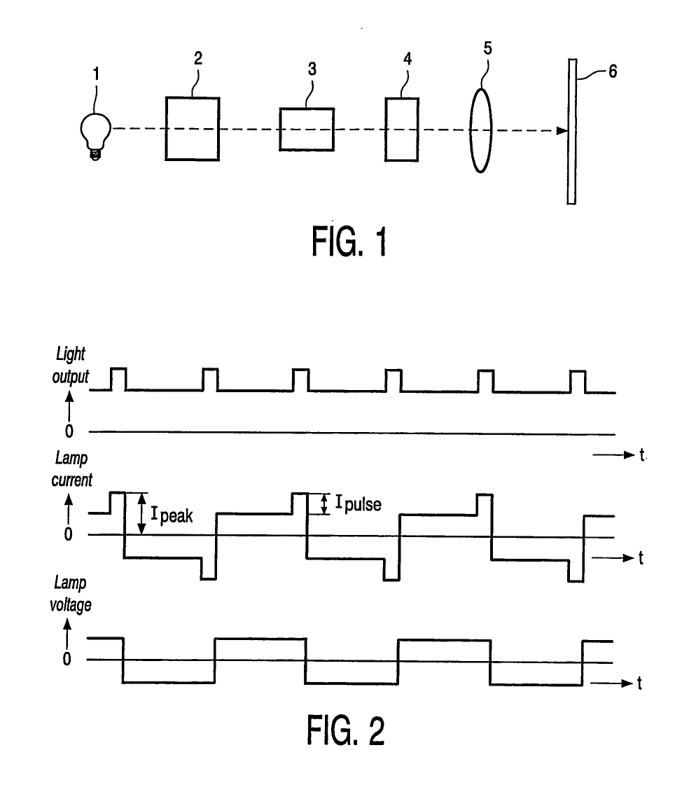

FIG. 1 is a schematic view of a projection system according to an embodiment of the invention;

FIG. 2 is a time diagram illustrating the light output, lamp current and lamp voltage, and the interrelation of the same;

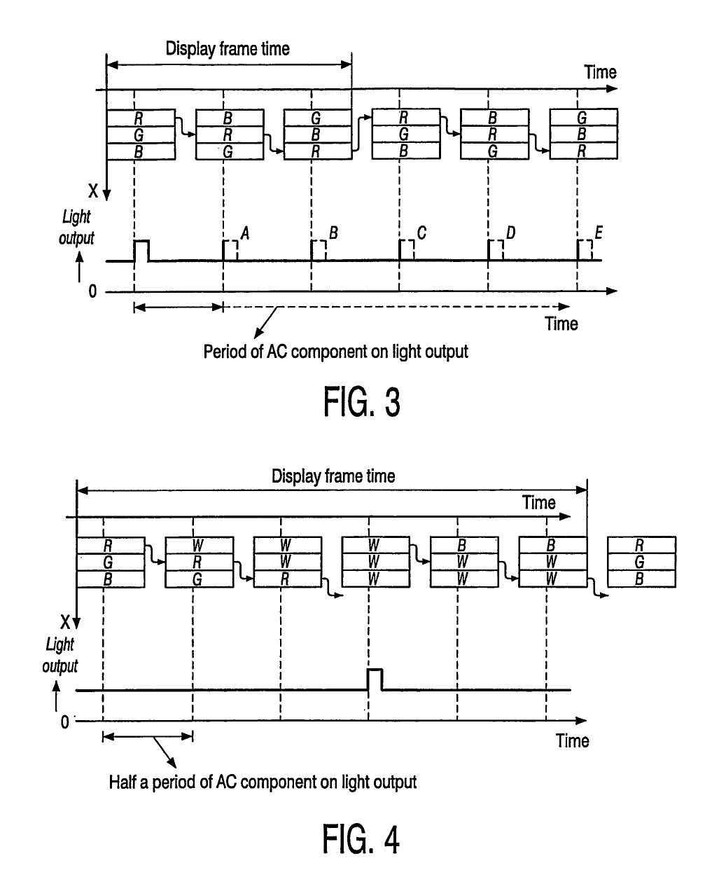

FIG. 3 is a time diagram illustrating different interrelation situations between the light output cycle and the sequential color cycle; and

FIG. 4 is a time diagram illustrating different interrelation situations between the light output cycle and the sequential color cycle.

Referring to FIG. 1, a color projection system according to an embodiment of the invention comprises an AC-operated light source 1 and a beam splitter 2. The light source is preferably a white light source, such as a xenon arc lamp or a high-pressure mercury gas discharge lamp, and reflectors and the like may be used for concentration and direction of the light. The beam splitter could be used to separate the emitted white light into red, green and blue beams. The beam splitter may use dichroic filters or mirrors for separating the light into primary colors, such as red, green and blue.

The light source is preferably driven with a square-wave current. The light source has a long lifetime because the square-wave current constantly changes polarity, a constant power is supplied to the light source and, before changing polarity, a current pulse is each time provided, driving the square-wave current to a predetermined strength which is larger than the current strength in between the current pulses. In the course of time, the amount of power in the current pulses increases relative to the amount of power in the current in between the current pulses. Light outputs from such light sources are proportional to the power dissipated by the light source. Therefore, such light sources are power-controlled to control their light output. The power control ensures that the amount of power dissipated by the light source is constant with time.

The diagram in FIG. 2 shows, as a function of time, the voltage V across the lamp 1, the current I through the lamp 1, and the amount of light L outputted by the lamp 1, respectively, all as a function of time and further illustrating the interdependencies between them. As is known in the art, it is advantageous for the current through and the voltage across the lamp 1 to constantly change polarity, as is shown in the diagram. It is also known that, in order to improve the arc stability of the light source 1 just before any change of polarity, the current through the lamp 1 should be increased to a peak value Ipeak (or simply Ipk).

In the known art, the setting of the control of the lamp voltage and lamp current are provided so that the current pulses Ipulse (or simply Ip) are synchronized with the sequential color cycle.

Furthermore, the projection system comprises a light valve device 4 for modulating light incident thereon in accordance with information of the image to be displayed, and an illumination unit 3 for illuminating said light valve device with the generated light of different colors in a sequential fashion. The light valve device is controlled in synchronization with said illumination unit in order to produce a colored output image.

The light valve is preferably constituted by a single light valve having a multiplicity of pixels, each pixel modulating light incident thereon in accordance with an input image signal. For example, the light valve could be a transmissive or reflective panel, such as a LCD panel, e.g. a LCoS (Liquid Crystal on Silicon) or a DMD (Digital (micro)Mirror Device). However, many other types of two-dimensional matrices with individually addressable pixels could be used as the light valve device as well.

The illumination unit preferably comprises scanning means to cause the color beams, preferably arranged in a band-shaped cross-section, to be sequentially scanned across the light valve. The scanning means preferably comprises a mechano-optical system for moving said band-shaped beams of different colors across the surface of the light valve so that beam portions of all different colors are simultaneously present on said light valve. Accordingly, as a band passes over the “top” of the active area of the panel, a band of light of that color again appears at the “bottom” of the panel, in a continuous sweep of three colors across the panel. For such a scanning operation, a rotating prism or the like may be used. It is also possible to use field-sequential color illumination, or other combinations of time and space-multiplexed illumination.

Even though the present invention may be used for pure color-sequential systems, it is preferably used in systems employing a combination of time and space-multiplexed color systems.

Prior to each color passing over a given row on the light valve, that row will be addressed, by display electronics with the appropriate color content of that portion of the image which is being displayed. The image is projected by a projection lens 5 onto a viewing surface, such as a screen 6 or the like. The sequence of lightbands, i.e. the sequential color (RGB) cycle, occurs so quickly as to give the viewer the impression of simultaneous full colors in the projected image. Furthermore, the cycle frequency should be high enough to give a viewer the impression of a steady, flicker-free image, for instance, 60 Hz for USA television.

In accordance with the present invention, the sequential color cycle and the AC cycle for the illumination unit are adapted to be out of phase with each other. Some examples of embodiments will now be discussed in relation to the diagram illustrated in FIG. 3.

We assume the voltage and current of the lamp to be resulting in a light output as depicted in FIG. 2 discussed above. In general, the color reproduction will be accomplished in two ways in this example:
Integration (human perception) of the display frame time, i.e. the sequential color cycle. The display frame frequency should be high enough to avoid color break-up.
Continuous spatial color split. Any certain moment of time, at least two, and preferably all colors are projected on the light valve. In this way, color reproduction also depends on the spatial addressing of the light valve.

In the situation denominated C in FIG. 3, both lamp current and the sequential color cycle/light valve addressing are in phase, likewise as in the conventional prior art solution. Suppose that homogenized gray will be projected from the system. In this case, too much red in the upper part of the screen, too much green in the middle part of the screen and too much blue in the lower part of the screen will be addressed during the pulse in the light output. The resulting visual effect is three horizontal R-G-B bars on the screen. Therefore, in-phase synchronization is not preferred. As a solution to this problem, the invention uses out-of-phase driving of the lamp current and the color sequence.

In the depicted situations denominated A and B, the lamp current is out of phase with the light valve addressing and the color sequence. Also, the period of time of the AC component of the light output is shorter (frequency is higher) than the display frame time. The effect of this arrangement is integration (human perception) of the light pulse during three periods of time of the AC component of the light output.

In the depicted situations denominated D and E, the lamp current is also out of phase with the light valve addressing. However, compared to the situations A, B, the period of time of the AC component of the light output is longer (frequency is lower) than the display frame time. The effect of this arrangement is integration (human perception) of light pulse during three periods of time of the AC output of the light output.

Depending on the maximally allowed lamp current, frequency situations A, B are normally preferred and even situations D, E are still feasible solutions.

In the above-mentioned examples, all of the three light pulses are composed to a white increase. Another way of dealing with the pulse in the lamp output is to insert white segments, and preferably three white segments, as is illustrated in FIG. 4. This results in a prolongation of the display frame time (sequential color cycle period), whereby the period of time of the AC component of the light output is equal to the display frame time.

The invention as discussed above may be used in many different applications, such as for light valve projection. It is especially useful in LCD-projectors and DMD-projectors. However, it may also be used in other applications where projection lenses are used.

It should be borne in mind that many other components may be substituted for the optical and mechanical system described above. Other arrangements of the components which provide sequential red, green and blue bands across the surface of a light valve may be utilized in conjunction with the present invention. For example, rather than a single source of white light, three sources of appropriately colored red, green and blue light may be utilized in conjunction with a scanning mechanism. Similarly, the color separation and scanning may be accomplished by means of, for example, a rotating wheel of colored filters or a rotating drum of colored filters. It is also noted that this invention can be used with any type of known electronic light valve such as transmissive or reflective LCDs, ferroelectric devices, deformable mirrors and the like. Additionally, the light path could be straight, as illustrated, or folded in a more compact arrangement. In certain applications, a two-color band rather than a three-band system could be used. Any combination of the above-discussed techniques and components may be used. Such and other obvious modifications must be considered to be within the scope of the present invention, as defined in the appended claims.

1. A color projection system comprising:
a light valve device (4) for modulating light incident thereon in accordance with information of an image to be displayed;
an AC-operated light source (1) for generating light of at least two different colors, and
an illumination unit (3) for illuminating said light valve device with said generated light of different colors in a sequential fashion;
wherein said light valve device (4) is controlled in synchronization with said illumination unit in order to produce a colored output image;
characterized in that the sequential color cycle of the light valve device (4) and the AC cycle for the illumination unit (3) are adapted to be out of phase with each other.

2. The projection system as claimed in claim 1, wherein the light valve device (4) is a transmissive or a reflective liquid crystal device.

3. The projection system as claimed in claim 1, wherein the illumination unit (3) is further adapted to generate different colors in a space-multiplexed fashion.

4. The projection system as claimed in claim 3, wherein the illumination unit (3) is operable to produce a continuous spatial color split, whereby at any certain moment of time all colors are projected on the light valve device.

5. The projection system as claimed in claim 3, wherein the illumination unit (3) is operable to provide scrolling color projection, wherein the colors are arranged with band-shaped cross-section.

6. The projection system as claimed in claim 1, wherein the illumination unit (3) comprises a source of white light, and a beam splitter for splitting said white light into a first, a second and a third color beam.

7. A method of controlling a projection system with an AC-operated light source (1) for generating light of at least two different colors, said light of different colors being illuminated on a light valve device (4) in a sequential fashion, the light valve being controlled to modulate the light incident thereon in accordance with information of an image to be displayed, and in synchronization with said color sequential illumination unit (3), in order to produce a colored output image, characterized in that the AC current cycle of the light source and the sequential color cycle are operated out of phase in relation to each other.

8. The method as claimed in claim 7, wherein the illumination of the light valve device (4) is further controlled to generate different colors in a space-multiplexed fashion.

9. The method as claimed in claim 7, wherein the period of time of the AC current cycle is longer than the period of time of the sequential color cycle.

10. The method as claimed in claim 7, wherein the period of time of the AC current cycle is shorter than the period of time of the sequential color cycle.

11. The method as claimed in claim 10, wherein the period of time of the AC current cycle is shorter than the display frame time of the sequential color cycle.

12. The method as claimed in claim 11, wherein at least one white segment is introduced in the sequential color cycle, providing an addition to the ordinary display frame time, wherein the period of time of the AC current cycle is shorter than said aggregate time period of the sequential color cycle.

13. The method as claimed in claim 7, wherein the AC-operated light source is driven with a square-wave current to constantly change the polarity of the square-wave current, to provide a constant power to the light source and to provide, each time before changing polarity, a current pulse driving the square-wave current to a predetermined strength which is larger than the current strength in between the current pulses.
